(19) United States
(12) Patent Application Publication
(10) Pub. No.: US 2004/0233236 A1
(43) Pub. Date: Nov. 25, 2004

(54) Apparatus and method for generating application programming interface

(76) Inventor: Dennis Woojun Yang, Revere, MA (US)

Correspondence Address: PAVEL POGODIN, ESQ., 617 NORTH DELAWARE STREET, SAN MATEO, CA, 94401, US

(21) Appl. No.: 10/616,634

(22) Filed: Jul. 9, 2003

Related U.S. Application Data
(60) Provisional application No. 60/473,239, filed on May 24, 2003.

(51) Int. Cl. G09G 5/00; G06F 9/44

(52) U.S. Cl. 345/763; 719/328

(57) ABSTRACT

Systems and methods consistent with principles of the present invention provide the ability to generate application program interfaces (API) for any target application with a graphical user interface (GUI). The APIs generated by the inventive system control the functionality of the target application by simulating the appropriate events of the windows system and using those simulated events to activate elements of the target application's graphical user interface. The target application responds to the aforesaid events generated by the inventive interfaces, just like it would respond to a user manually invoking the corresponding elements of the application's graphical user interface. The inventive methodology can be used in converting windows-type applications into fully communicable architectural services. For example, the described methodology can be used to enable various applications to operate as web services.

### CROSS-REFERENCE TO RELATED APPLICATION

This regular U.S. patent application is based on and claims the benefit of U.S. Provisional patent application Ser. No. 60/473,239, filed May 24, 2003, the entire disclosure of which is relied upon and incorporated by reference herein.

### FIELD OF THE INVENTION

The present invention generally relates to generating application programming interfaces (API). Specifically, this invention relates to generating application programming interfaces using application's graphical user interface.

### DESCRIPTION OF THE RELATED ART

In the era of the widespread use of the Internet, there is a strong and widely recognized need to make various software applications available through the web. A standard way for accomplishing this task is by configuring an application as a web service. A web service is a modular application that can be described, published, located, and invoked across the web. A web service performs functions, which can be anything from simple requests to complicated business processes. Once a web service is deployed, other applications or other web services can discover and invoke the deployed service cross the web.

Deployed web services are usually invoked using Simple Object Access Protocol (hereinafter “SOAP”) messages. SOAP is a well-known in the art lightweight messaging protocol that allows objects of any kind, on any platform, written in any language to cross-communicate. SOAP messages are encoded in eXtensible Markup Language (hereinafter “XML”) and typically transported by means of a Hypertext Transfer Protocol (hereinafter “HTTP”). XML and HTTP are also well known to persons of skill in the art. Unlike other distributed computing technologies, web services are loosely coupled and can dynamically locate and interact with various other components available on the internet to provide services.

As stated hereinabove, a web service can be invoked using an XML message such as a SOAP message through a well-defined message exchange pattern. The aforesaid message exchange pattern of a web service is customarily defined in a Web Services Description Language (WSDL) document, said document providing a description of the data required to invoke the web service.

To operate as web service, application's interface must possess special characteristics that would make the application available through the web. Specifically, the application would have to properly interpret and properly respond to the aforementioned SOAP messages and translate said messages into its internal commands. In addition, the application needs to be able to generate its output in a form communicable through the aforesaid SOAP message protocol.

The vast majority of the existing software applications, such as word processors, databases, etc., do not possess interfaces having the above-described characteristics. Accordingly, those applications need to be re-written to operate as web services. Such re-writing usually requires deep knowledge of the internal operation of the target application and, for this reason, it is expensive and time consuming. What is needed is a simple and inexpensive way of converting applications into services.

### SUMMARY OF THE INVENTION

The present invention is directed to methods and systems that substantially obviate one or more of the above and other problems associated with providing application programming interfaces for windows-based applications. Consistent with exemplary embodiments of the present invention, there are provided methods for generating application programming interfaces for application with graphical user interface.

According to an embodiment of the inventive technique, a target application having a graphical user interface is provided with an application programming interface. The inventive method generates a computer code for activating at least one element of the graphical user interface of the target application, such that the activation of that element causes the target application to execute a desired function.

According to another aspect of the embodiment of the inventive technique, there is provided a method for causing a target application having a graphical user interface to execute a function. The inventive method provides for simulation of an event of a windows system, such that the simulated event activates an element of the graphical user interface of the target application, causing the target application to execute a desired function.

According to yet another aspect of the embodiment of the inventive technique, there is provided a method for enabling a first software application to control a second software application having a graphical user interface. According to the inventive method, the first software application causes simulation of an event of a windows system, such that the simulated event activates an element of said graphical user interface of the second application and causes the second application to execute a desired function.

According to yet another aspect of an embodiment of the inventive technique, there is provided a computer system programmed to provide a target application with an application programming interface. The inventive system generates a computer code for activating at least one element of the graphical user interface of the target application, such that the activation of that element causes the target application to execute a desired function.

According to another aspect of the embodiment of the inventive technique, there is provided a computer software for causing a target application having a graphical user interface to execute a function. The inventive software provides for simulation of an event of a windows system, such that the simulated event activates an element of the graphical user interface of the target application, causing the target application to execute a desired function.

According to yet another aspect of the embodiment of the inventive technique, there is provided a computer software for enabling a first software application to control a second software application having a graphical user interface. The first software application causes simulation of an event of a windows system, such that the simulated event activates an element of said graphical user interface of the second application which causes the second application to execute a desired function.

According to yet another aspect of an embodiment of the inventive technique, there is provided a computer system programmed to provide a target application with an application programming interface. The inventive system generates a computer code for activating at least one element of the graphical user interface of the target application, such that the activation of that element causes the target application to execute a desired function.

According to another aspect of the embodiment of the inventive technique, there is provided a system programmed to cause a target application having a graphical user interface to execute a function. The inventive system provides for simulation of an event of a windows system, such that the simulated event activates an element of the graphical user interface of the target application, causing the target application to execute a desired function.

According to yet another aspect of the embodiment of the inventive technique, there is provided a system programmed to enable a first software application to control a second software application having a graphical user interface. The first software application causes simulation of an event of a windows system, such that the simulated event activates an element of said graphical user interface of the second application causes the second application to execute a desired function.

Additional aspects related to the invention will be set forth in part in the description which follows, and in part will be obvious from the description, or may be learned by practice of the invention. Aspects of the invention may be realized and attained by means of the elements and combinations particularly pointed out in the appended claims.

It is to be understood that both the foregoing and the following descriptions are exemplary and explanatory only and are not intended to limit the claimed invention in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 depicts a block-diagram illustrating operation of conventional windows system events mechanism;

FIG. 2 depicts a block-diagram illustrating an embodiment of the inventive technique; and

FIG. 3 depicts a block-diagram illustrating another embodiment of the inventive technique.

### DETAILED DESCRIPTION

In the following detailed description, reference will be made to the accompanying drawings, in which identical functional elements are designated with like numerals. The aforementioned accompanying drawings show by way of illustration, and not by way of limitation, specific implementations consistent with principles of the present invention. These implementations are described in sufficient detail to enable those skilled in the art to practice the invention and it is to be understood that other implementations may be utilized and that structural changes may be made without departing from the scope and spirit of present invention. The following detailed description is, therefore, not to be construed in a limited sense.

Systems and methods consistent with principles of the present invention provide the ability to generate application programming interfaces (API) for any target application with a graphical user interface (GUI). The APls generated by the inventive system control the functionality of the target application by simulating appropriate events of the windows system and using those simulated events to activate elements of the target application's graphical user interface, which in turn, cause the target application to execute a desired function.

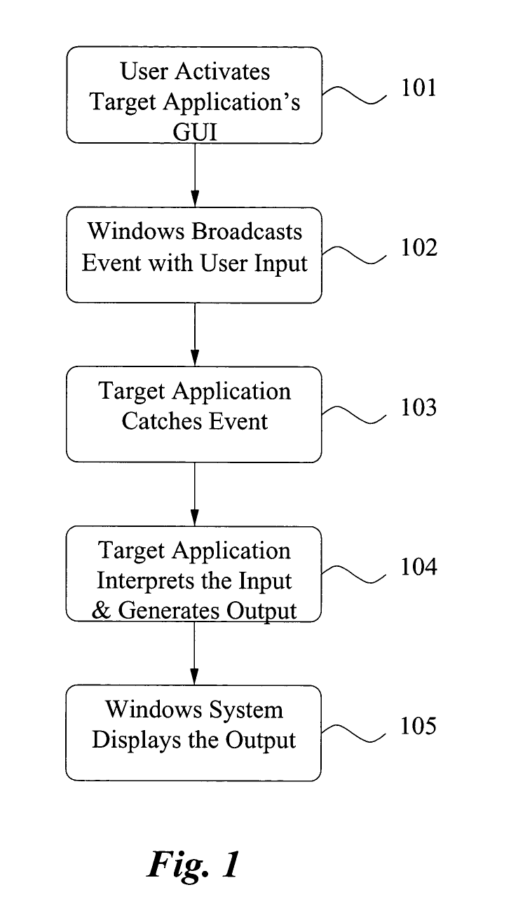

Reference will now be made to FIG. 1, which illustrates the operation of the conventional windows events mechanism. It is well known in the art that in accordance with principles of operation of a windows system, when at 101 a user activates a button, textbox or other similar element of applications' graphical user interface, the aforesaid windows system broadcasts a windows event containing information on the identity of the activated graphical component as well as the data input by the user, see FIG. 1 at 102. The target application monitors all events broadcasted by the windows system and identifies those events that correspond to the elements of that application's graphical user interface, as designated by numeral 103 in FIG. 1. After identifying the proper event, the application interprets the corresponding user input and performs the function which was requested by the user, 104. Finally, the application generates events carrying the information on the output of the action, causing the windows system to display the output at 105.

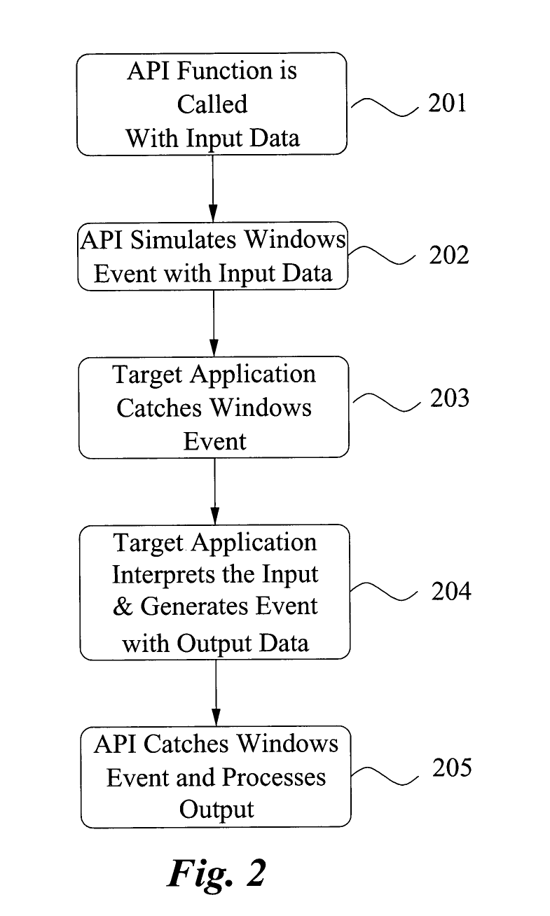

The inventive technique utilizes the aforesaid windows system events mechanism to enable easy control of the functionality of the target application, see FIG. 2. However, unlike the above-described case of a user manually activating buttons on the screen, which causes the generation of the corresponding window system events, in the inventive methodology, the aforesaid windows system events are automatically generated by the application programming interface, see FIG. 2 at 201 and 202. The target application responds to the aforesaid windows system events simulated by the inventive interfaces, just like it would respond to a user manually invoking the corresponding elements of the application's graphical user interface. Specifically, the target application interprets the input data, performs the desired function and provides its output in a form of another windows system event, as designated by numeral 204 in FIG. 2. Once this is done, all that is left is for the API to identify that event in order to get the output data, see FIG. 2 at 205.

One exemplary embodiment of the inventive system is a computer software product for generating an application programming interface for an application with a graphical user interface. As will be described in detail below, the aforesaid embodiment of the inventive methodology may itself comprise a graphical user interface which enables the user of the inventive system to select the components of the graphical user interface of the target application that drive such target application as well as the required sequences for activating those graphical components. In response the user's selections, the aforesaid exemplary embodiment generates an application programming interface for the target application. Said generated application programming interface exposes the full functionality of the target application to any other application in the computer system, and, optionally, other clients on the computer network.

One of the primary advantages of using the graphical user interface to control the target application is that the resultant API would have the least complexity. Specifically, as it is well known in the art, user applications may consist of one or more tiers, also called layers. [describe tiers in more detail, give some examples] Each such layer may not expose its own API through which communications can occur among the aforesaid tiers. Regardless whether these tiers have API or not, the communications between tiers usually decrease in complexity as the level of abstraction they cover increases. Hence, if there is a set of application programming interfaces that governs the graphical user interface of an application, that set is the least complex among all possible sets of API of sub-tiers that comprise the application, as the GUI represents the highest level of abstraction among all tiers. Because the inventive system builds the application programming interface for the target application based on the target's graphical user interface, the resultant API provides the easiest way of communicating with the target application.

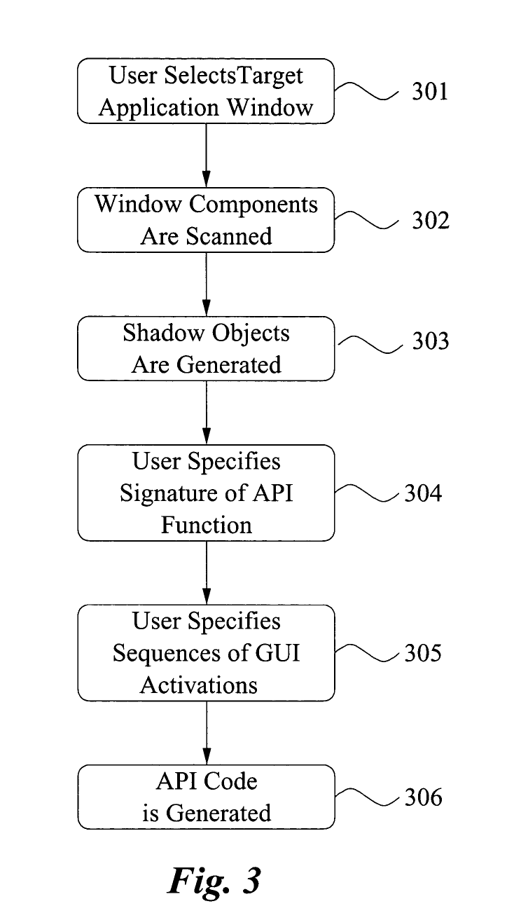

Reference will now be made to FIG. 3, which depicts an exemplary embodiment of the inventive concept. According to one feature of the described embodiment, the user of the inventive system may be asked specify the target application, select the window components that drive the target application, and identify the sequences of activations of said window components required to cause the target application to execute specific functions. As the first step, the user may be asked to select the target application, or windows that comprise the whole or portions of that application's graphical user interface. Said first step is designated by numeral 301 in FIG. 3. It will be understood by persons of skill in the art that the exact method for specifying the target application is not essential to the present invention. An embodiment of the inventive system may be provided with a graphical user interface that may be utilized by the user to manually select (using, for example, a click of a mouse button) one or more windows associated with the target application. In another embodiment, the target application may be specified using a configuration file or a command-line input.

Once the selection of the target has been made in the described manner, the described embodiment of the inventive system scans all the resident window components associated with the selected windows, including, without limitation, buttons, check boxes, list/combo boxes, edit boxes, menus, etc., see FIG. 3 at 302. Subsequently, at step 303, said embodiment generates an object for each such window component, such that the generated objects act on behalf of their counterpart window components. Said generated objects may be implemented in most popular languages such as C, C++, Java, or Java Script. These objects are called shadow objects. For example, a shadow object that represents an edit box can programmatically take calls that ask the box to display a certain message. API at this level gives the ultimate flexibility to programmers who wish to control the target application on an individual window components level, just as a human user would.

The concept of the aforementioned shadow objects is based on the fact that the target application always sets up its window hierarchy in exactly the same way each time said application is executed by the user. In addition, all the window components are windows themselves. Therefore, an embodiment of the inventive system is provided with a capability to draw a map of the window hierarchy, making predetermined navigation through the hierarchy to a particular window possible. In other words, each aforementioned shadow object contains the information on the sequence of activations of various window components that is necessary to get to the corresponding window of the target application.

Thus, the aforementioned route to a particular window from a predetermined navigation starting point enables a static mapping between the each window with its shadow representation, and said mapping gets physically manifested in the form of the shadow object having the full handle to the window. Programmatically speaking, once the aforesaid handle to a window is obtained, it becomes possible to control the window at will, hence the shadow object is fully capable of acting on behalf of its counterpart window component. The inventive system uses this idea to control applications that run on Win32, Unix, and Linux OS. In addition, the screen scraping technique can be utilized to handle mainframe applications in generating window components level API.

It should be noted that the aforesaid application programming interface may be generated to control individual window components of an application, as well as functionality of individual applications as a whole, and even groups of applications. Specifically, the creation of the APIs in the above-described manner turns the applications into fully communicable architectural services that can be used in any distributed computing contexts, including, without limitation, EAI (Enterprise Application Integration) and Web services. Accordingly, while the first aspect of the invention provides the ability to make incommunicable applications communicable or already communicable applications most easily communicable, the second aspect thereof makes the generated APIs more meaningful. This is accomplished through increasing the level of abstraction by adding a layer that accepts and responds in business terms while making a series of window components API calls internally, thereby turning the applications into services.

First, as will be undoubtedly understood by persons skilled in the art, the aforesaid shadow objects provide the application programming interface at the window components level. In other words, each individual window component of the target application's graphical user interface can be controlled by invoking the corresponding shadow object. According to the inventive methodology, the shadow objects can in turn be used to build individual applications API. As it will be appreciated, window components level API is granular enough to programmatically control the applications just as a human would, but this level of granularity is often not required to access the intelligence that is implemented by the applications. Specifically, more often than not, a series of simple acts of choosing an item in a menu, filling a few edit boxes, and clicking a few buttons is all that is required to run an aspect of an application. Accordingly, it is desirable to provide an API that would enable the execution of a functional aspect of an application, such as submission of an order, without the need to program at the level of individual window components.

Individual application API is, in and of itself, an application, which understands how to process requests in business terms in the context of how its target application interprets and responds to the requests. It implements the application specific knowledge of what sequences of window components activations need to take place in order to process and respond to a certain request, which is what is needed to turn the application into a service.

This API consists of what is called UOW (Unit Of Work). Each UOW handles a specific business process, such as creating a new order, or changing the quantity of an ordered item, and each business process is equivalent to a use case of UML (Unified Modeling Language). If making a silent application talk is a technical merit of the described embodiment of the inventive concept, then specifying the UOW is its business merit.

When developing any software system, including EAI or Web service initiatives, one of the most crucial tasks is capturing and communicating functional requirements. Persons of skill in the art have invented various ways of doing this, but none has been successful in terms of delivering a mechanism with which one can accurately and completely capture functional requirements that are verifiable. Even when functional requirements have been captured in their best form, they are often interpreted differently by different individuals. Using the inventive methodology rectifies this problem rather radically because the user of the software only needs to know what window components need to be activated in what sequence; a series of screen shots, along with minimal textual direction, is all that is needed to both accurately and completely capture functional requirements that are verifiable. With such a functional requirements document, the user may define a function signature and a sequence of involved window components as well as the specifics on the action for each of the processes. Once the defining activities are finished, the generation and also the deployment of individual applications API as, for example, a Web service can be achieved with a click of a button.

The individual application level API may also be provided in all the programming languages listed hereinabove, and is sufficient for purposes of development of most EAI or Web applications. It should be noted, however, that some enterprise-wide business processes involve the participation of multiple applications. To address this problem, the inventive methodology treats an additional application as just another navigational hierarchy, providing a framework for combining multiple sets of individual applications API into one large group API.

The resultant group applications API is the highest level of API that the described embodiment of the inventive concept generates, and the mechanisms through which it does so are substantially similar to those of individual applications API. However, the aforesaid group applications API adds another layer of abstraction on top of the described sets of API that govern individual applications, as illustrated in detail in the following description.

In more detail, the level of abstraction of the generated API may be further increased to provide a package of units of work spanning across multiple applications. For example, Mobile Agent Technology, Inc., provides an agent-based distributed computing infrastructure (“Cascadia™”) with which the output of the inventive system works in a more robust manner. Cascadia™ is a software platform with which programmers can develop and manage mobile agent-based distributed systems. It provides, among other capabilities, the facilities to manage transport of agents, queue, persistence, security, collaboration, event, and administration. The output of the inventive system may be used in conjunction with any other distributed computing paradigm such as CORBA, DCOM, or RMI to implement the layout described hereinabove. The fact that the output of the inventive system is highly standardized, greatly facilitates this capability. However, it should be noted that the aforementioned Cascadia's facilities are among the easiest to use, and, therefore, may be considered as a default alternative.

The three sets of API described above are generated with a predetermined set of input parameters, which may be fed into the inventive system in three successive stages, and specifically: (1) selecting needed window components 302, (2) specifying sequences and activities for window components for business processes 305, and (3) generating and deploying codes 306 in FIG. 3. The user interaction is described in an attempt to illustrate the functionality of the software, and further, to emphasize the easiness of executing the functionality. Note that the target applications are assumed to be Win32 applications for the sake of simplicity. Similar interactions apply to other platforms.

The first step in generating API at any level is selecting all the window components that play a role in executing the business processes that are to be processed. If the functional requirements are captured with screen shots as discussed earlier, then selecting the involved window components is reduced to a mechanical task of selecting the uppermost windows of target applications, which will cause the described embodiment of the inventive system to scan and register all the window components indiscriminately, as shown by numeral 302 in FIG. 3, followed by deleting unnecessary components. Alternatively, the user may selectively choose only the necessary window components.

In an embodiment of the inventive system, the selected components are displayed in their native hierarchy relative to the applications that own/created them, as in the tree view, along with information that helps to identify the displayed components. Such identifying information includes class type, caption, and position in the hierarchy, etc., and may be substituted with any other information that will distinctively identify the displayed components in the best way, as judged by the user. Selecting multiple applications in one session is carried out by repeating the selection process described above for each of the applications, wherein each application is accompanied by its own tree of hierarchy of window components.

The specification of the unit of work (UOW) will now be described. Once the desired window components have been selected and proper identification information has been assigned to them, they are ready to become a part of UOW specification. Just as with the window components selection process, if functional requirements describe business processes with screen shots, specifying UOW is reduced to a mechanical task of arranging window components in the correct order with proper activations assigned to them. This embodiment may also provide graphical interface for specifying UOW for ultimate easiness as well as scripting capability for maximum flexibility. Note that according to another feature of the present invention, the user would be able to define the UOW by simply using the target applications as they would be used in conducting the normal business operations (e.g. submitting an order).

For most business processes, such as adding a customer or an order to a database, a series of simple acts, such as choosing an item in a menu, filling a few edit boxes, and clicking a few buttons is all that is required to execute them, and the graphical interface will be sufficient to implement them. If, however, the user of the inventive system wishes to go beyond the limitations of graphical interface, he can use either the accompanying scripting facility, or even use any third party development environment and use window components API, as the generated API at any level uses only the standard technologies without the use of a proprietary technology.

When defining the aforesaid UOW, the user of the inventive system may start by defining the signature of the corresponding function of the application programming interface, see FIG. 3 at 304. The function signature may consist of the function name, input parameters, and return data type. Specifically, the function name provides the outside entities with the ability to identify the services that are provided by the target application.

The input parameters of the function provide the input data to the window components of the target application that are capable of accepting data, such as edit boxes or combo boxes. To start a particular instance of a generic business process, such as insertion of an order into the database, the input data parameters will be passed to the target application by the generated application programming interface through the aforesaid graphical user interface components of the target application.

When a sequence of actions of involved components has finished its course, the result will be returned in the data type as defined by the return data type. After the function signature has been defined, the window components that play a role in delivering the business process are pulled from a pool of all the available components and arranged in a particular order, as defined by the screen shots, by simple drag and drop with the mouse. Once the appropriate window components have been placed in right places within the sequence, the user selects an action among all the possible actions for each of the window components, and indicates the origin of the input data for components that expect an input, i.e., the input data can come from outside entities that call this particular API in the form of parameters, or as a result of clicking a button as displayed in an edit box within one of the involved window components. The user repeats this process for each of the business processes. Once window components selection process is completed, the described embodiment generates and deploys the code for the API.

One of the exemplary applications of the inventive methodology and its embodiments is conversion of windows-type applications into fully communicable architectural services. Specifically, the described methodology can be used to enable various applications to function as web services.

To function as a web service, a specific software application must be provided with an interface (hereinafter “service interface”) that is capable of communicating over the web in accordance with the aforesaid message exchange pattern and the SOAP protocol. On the other hand, the service interface must be able to control the full functionality of the target application such that this functionality is exposed to the user of the service. This can be accomplished in two principal ways.

First, the service interface may use the application programming interface to invoke functions or methods controlling the functionality of the target application. The aforesaid API customarily comes in a form of a library of functions or classes that can be invoked in order to control the internal functionality of the target application. If the aforementioned API exists, the target application can be controlled by linking against such a library and invoking specific functions or methods therein that cause the target application to perform the desired function. The major drawback of using the API method is that said APIs are specific to each particular application, and that they are not readily available for many applications.

The inventive system may be used to automatically generate the code for a set of functions that may control the full functionality of the target application or applications and, at the same time, provide the aforementioned web-service capable communications interface. As it would be appreciated by those of skill in the art, the creation of the aforesaid API would not require knowledge of any proprietary information regarding the target application. It will also not require any modifications to the target. Accordingly, the creation of such an API will be easy and cost-effective. The API created in the above-described manner would enable one or more windows-type target applications to be used as a web service.

In addition to enabling applications to function as web services, the inventive concept of generating application programming interfaces can be utilized to accomplish enterprise application integration (EAI), which provides a common framework for integrating incompatible and distributed systems. The inventive concept permits applications, databases and mainframes communicate and interact with each other through the application programming interfaces generated by the inventive system.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention.

Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for providing a target application with an application programming interface, said target application comprising a graphical user interface, said method comprising generating a computer code for activating at least one element of said graphical user interface of said target application, wherein said activation of said at least one element causes said target application to execute a desired function.

2. The method of claim 1, wherein said generated computer code activates said at least one element of said graphical user interface of said target application by simulating at least one event of a windows system.

3. The method of claim 1, wherein said generated computer code comprises at least one shadow object for activating said at least one element of said graphical user interface.

4. The method of claim 3, wherein said shadow object activates said at least one element of said graphical user interface by sequentially activating a predetermined plurality of windows.

5. The method of claim 1, further comprising requesting a user to select said at least one element of said graphical user interface of said target application.

6. The method of claim 1, further comprising selecting at least one window associated with said target application, wherein said selected window comprises said at least one element of said graphical user interface of said target application.

7. The method of claim 6, further comprising scanning said selected window for its window components.

8. The method of claim 1, further comprising generating a second computer code for a function causing said target application to execute a predetermined action, wherein said function comprises a call to said at least one shadow object.

9. The method of claim 8, further comprising requesting a user to specify a signature of said function.

10. The method of claim 9, wherein said specified signature of said function comprises a name of said function, an input data parameters of said function and an output data parameters of said function.

11. The method of claim 8, further comprising requesting a user to specify a sequence of components of said graphical user interface of said target application that are required to be activated in order to cause said target application to execute said predetermined action.

12. The method of claim 1, wherein said provided application programming interface is capable of communicating in accordance with SOAP protocol.

13. A method for causing a target application to execute a function, said target application comprising a graphical user interface, said method comprising simulating an event of a windows system, said event activating an element of said graphical user interface of said target application, wherein said activation of said element causes said target application to execute said function.

14. A method for enabling first software application to control second software application, said second software application having a graphical user interface, said method comprising using said first software application to simulate an event of a windows system, said simulated event activating an element of said graphical user interface of said second application, wherein said activation of said element causes said second application to execute a desired function.

15. A computer software for providing a target application with an application programming interface, said target application comprising a graphical user interface, said providing comprising generating a computer code for activating at least one element of said graphical user interface of said target application, wherein said activation of said at least one element causes said target application to execute a desired function.

16. The computer software of claim 15, wherein said generated computer code activates said at least one element of said graphical user interface of said target application by simulating at least one event of a windows system.

17. The computer software of claim 15, wherein said generated computer code comprises at least one shadow object for activating said at least one element of said graphical user interface.

18. The computer software of claim 17, wherein said shadow object activates said at least one element of said graphical user interface by sequentially activating a predetermined plurality of windows.

19. The computer software of claim 15, further comprising requesting a user to select said at least one element of said graphical user interface of said target application.

20. The computer software of claim 15, further comprising selecting at least one window associated with said target application, wherein said selected window comprises said at least one element of said graphical user interface of said target application.

21. The computer software of claim 20, further comprising scanning said selected window for its window components.

22. The computer software of claim 15, further comprising generating a second computer code for a function causing said target application to execute a predetermined action, wherein said function comprises a call to said at least one shadow object.

23. The computer software of claim 22, further comprising requesting a user to specify a signature of said function.

24. The computer software of claim 23, wherein said specified signature of said function comprises a name of said function, an input data parameters of said function and an output data parameters of said function.

25. The computer software of claim 22, further comprising requesting a user to specify a sequence of components of said graphical user interface of said target application that are required to be activated in order to cause said target application to execute said predetermined action.

26. The computer software of claim 15, wherein said provided application programming interface is capable of communicating in accordance with SOAP protocol.

27. A computer software for causing a target application to execute a function, said target application comprising a graphical user interface, said causing comprising simulating an event of a windows system, said event activating an element of said graphical user interface of said target application, wherein said activation of said element causes said target application to execute said function.

28. A computer software for enabling first software application to control second software application, said second software application having a graphical user interface, said enabling comprising using said first software application to simulate an event of a windows system, said simulated event activating an element of said graphical user interface of said second application, wherein said activation of said element causes said second application to execute a desired function.

29. A computer system programmed for providing a target application with an application programming interface, said target application comprising a graphical user interface, said providing comprising generating a computer code for activating at least one element of said graphical user interface of said target application, wherein said activation of said at least one element causes said target application to execute a desired function.

30. The computer system of claim 29, wherein said generated computer code activates said at least one element of said graphical user interface of said target application by simulating at least one event of a windows system.

31. The computer system of claim 29, wherein said generated computer code comprises at least one shadow object for activating said at least one element of said graphical user interface.

32. The computer system of claim 31, wherein said shadow object activates said at least one element of said graphical user interface by sequentially activating a predetermined plurality of windows.

33. The computer system of claim 29, further comprising requesting a user to select said at least one element of said graphical user interface of said target application.

34. The computer system of claim 29, further comprising selecting at least one window associated with said target application, wherein said selected window comprises said at least one element of said graphical user interface of said target application.

35. The computer system of claim 34, further comprising scanning said selected window for its window components.

36. The computer system of claim 29, further comprising generating a second computer code for a function causing said target application to execute a predetermined action, wherein said function comprises a call to said at least one shadow object.

37. The computer system of claim 36, further comprising requesting a user to specify a signature of said function.

38. The computer system of claim 37, wherein said specified signature of said function comprises a name of said function, an input data parameters of said function and an output data parameters of said function.

39. The computer system of claim 36, further comprising requesting a user to specify a sequence of components of said graphical user interface of said target application that are required to be activated in order to cause said target application to execute said predetermined action.

40. The computer system of claim 29, wherein said provided application programming interface is capable of communicating in accordance with SOAP protocol.

41. A computer system for causing a target application to execute a function, said target application comprising a graphical user interface, said causing comprising simulating an event of a windows system, said event activating an element of said graphical user interface of said target application, wherein said activation of said element causes said target application to execute said function.

42. A computer system for enabling a first software application to control a second software application, said second software application having a graphical user interface, said enabling comprising using said first software application to simulate an event of a windows system, said simulated event activating an element of said graphical user interface of said second application, wherein said activation of said element causes said second application to execute a desired function.
